(19) United States
(12) Patent Application Publication
(10) Pub. No.: US 2026/0193281 A1
(43) Pub. Date: Jul. 9, 2026

(54) PHYTIC ACID OLIGOMER

(71) Applicant: HOCHSCHULE NIEDERRHEIN, Krefeld (DE)

(72) Inventors: Michael Peter Dornbusch, Düsseldorf (DE); Patrick Böhm, Krefeld (DE)

(73) Assignee: HOCHSCHULE NIEDERRHEIN, Krefeld (DE)

(21) Appl. No.: 18/862,069

(22) PCT Filed: May 2, 2023
(86) PCT No.: PCT/EP2023/061519

§ 371 Date: Oct. 31, 2024

(30) Foreign Application Priority Data
May 3, 2022 (DE) 10 2022 110 908.9

(51) Int. Cl. C07F 9/12; C08J 3/24

(52) U.S. Cl. CPC C07F 9/12; C08J 3/24; C08J 2333/14; C08J 2363/00

(57) ABSTRACT

The present invention relates to a phytic acid oligomer, to a process for preparing the phytic acid oligomer, to the use of the phytic acid oligomer, to a process for preparing polymers comprising the phytic acid oligomer, and to polymers prepared according to said process.

The present invention relates to a phytic acid oligomer, a method for producing the phytic acid oligomer, a use of the phytic acid oligomer, a method for producing polymer compositions comprising the phytic acid oligomer, and polymer compositions produced by the method.

Phytic acid is known per se, but has so far found little industrial application. Phytic acid is obtained, for example, from maize steep liquor and rice hulls and can be found in nature as an anion.

A major challenge in the polymer industry is to make better use of raw materials obtained from renewable sources. One problem with the use of raw materials from renewable sources is that they often have a rather complex structure and are therefore difficult to process into polymers with controllable properties.

The object is thus to provide novel starting products for the production of polymers with good properties that can be obtained from renewable raw materials. This object is achieved by the phytic acid oligomer according to claim 1, the method for producing the phytic acid oligomer according to claim 6, the use according to claim 8, the method for producing a polymer composition according to claim 9, and the polymer composition according to claim 10. Preferred embodiments of the invention are provided in the subclaims and in the description, wherein further features described or shown in the subclaims or in the description individually or in any combination, may constitute a subject matter of the invention, unless the context clearly indicates otherwise.

The invention proposes a phytic acid oligomer consisting of at least two independently selected groups of the following formula (I)

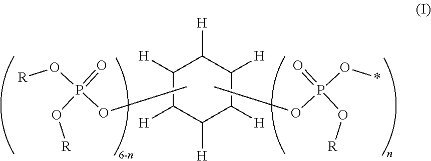

and at least one independently selected group of the following formula (II)

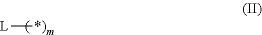

wherein
n is independently selected from an integer in a range of greater than or equal to 1 to less than or equal to 6,
m is independently selected from an integer in a range of greater than or equal to 2 to less than or equal to 6,
all components R are independently selected from H or an organic residue, and
L is selected from an organic linker or a siloxane linker;
and wherein each group of formula (II) respectively connects at least two independent groups of formula (I) to one another via covalent bonds, wherein the asterisks “*” represent bonding positions.

Surprisingly, it could be shown that the phytic acid oligomer is particularly easy to produce and can also be readily processed with other reactants to form polymer compositions with good properties. In particular, it could be shown surprisingly that the phytic acid oligomer, despite its complex structure, can be easily reacted into polymer compositions.

Furthermore, it could be shown surprisingly that the phytic acid oligomer, despite the high number of functional groups of phytic acid, can be predictably and easily produced in a one-pot reaction without an uncontrolled formation of long-chain and/or branched polymers. Furthermore, it could be shown surprisingly that the production of the phytic acid oligomer is also possible without the use of anhydrides, as is usually necessary in the production of phosphoric acid esters.

Without being bound to theory, it is assumed that the reaction to the phytic acid oligomer proceeds particularly controlled because the acid groups of the phytic acid do not all have the same acid constants.

Furthermore, it could be shown that, in particular by selecting the linker and organic residues, as well as the number of residues R that are not H, the polarity of the phytic acid oligomer can be adjusted. Accordingly, the phytic acid oligomer can be advantageously adapted to different applications.

As a result, the phytic acid oligomer is advantageously a particular environmentally friendly starting material for polymers, because its constituents can, to a large extent, simply be obtained from renewable raw materials. In addition, by use of the phytic acid oligomer a functionalization of a polymer composition with phosphates can be achieved, which is why the resulting polymer compositions can have good properties with respect to corrosion protection.

It may preferably be provided that the phytic acid oligomer has a maximum of 20 independently selected groups of formula (I), more preferably a maximum of 15, more preferably a maximum of 10, more preferably a maximum of 6, for example 5, 4 or 3.

It may preferably be provided that the phytic acid oligomer has a maximum of 19 independently selected groups of formula (II), more preferably a maximum of 14, more preferably a maximum of 9, particularly preferably a maximum of 5, for example 4, 3 or 2.

It may preferably be provided that the phytic acid oligomer has at least one independently selected group of formula (II) less than independently selected groups of formula (I).

It may preferably be provided that in the phytic acid oligomer at least two of all components R together are selected from H, and the remaining R's are not H.

It may preferably be provided that in the phytic acid oligomer greater than or equal to 5% to less than or equal to 100% of all components R together are selected from H, based on the total number of components R, preferably greater than or equal to 9% to less than or equal to 91%, more preferably greater than or equal to 10% to less than or equal to 90%, more preferably greater than or equal to 12% to less than or equal to 70%, more preferably greater than or equal to 14% to less than or equal to 50%, more preferably greater than or equal to 16% to less than or equal to 30%, particularly preferably greater than or equal to 18% to less than or equal to 20%, wherein the remaining components R are respectively not H.

It may preferably be provided that formula (I) is selected from formula (Ia)

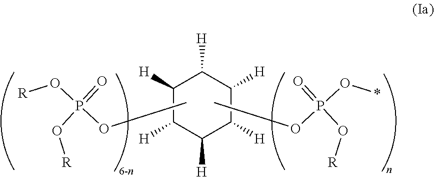

wherein R, n and * are as defined for formula (I).

It may preferably be provided that formula (I) is selected from formula (Ib)

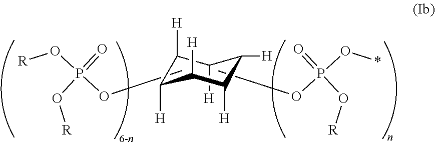

wherein R, n and * are as defined for formula (I).

It may preferably be provided that n is independently selected from an integer in a range from greater than or equal to 1 to less than or equal to 5, more preferably from greater than or equal to 1 to less than or equal to 4, particularly preferably from greater than or equal to 1 to less than or equal to 3, for example 1 or 2.

It may preferably be provided that the phytic acid oligomer has at least two groups of formula (I) in which n is selected from 1.

It may preferably be provided that the phytic acid oligomer has at least two groups of formula (I) in which n is selected from 1, and at least one group of formula (I) in which n is selected from 2.

It may preferably be provided that the phytic acid oligomer has at least three groups of formula (I) in which n is selected from 1, and at least one group of formula (I) in which n is selected from 3.

It may preferably be provided that the phytic acid oligomer has at least three groups of formula (I) in which n is selected from 1, at least one group of formula (I) in which n is selected from 3, and at least one group of formula (I) in which n is selected from 2.

It may preferably be provided that groups of formula (I) are independently selected from the following formula (I-1) in the case where n is selected from 1:

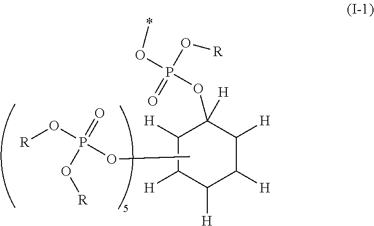

wherein R and * are as defined for formula (I).

It may preferably be provided that groups of formula (I) are independently selected from the following formulas (I-2a), (I-2b), and (I-2c) in the case where n is selected from 2:

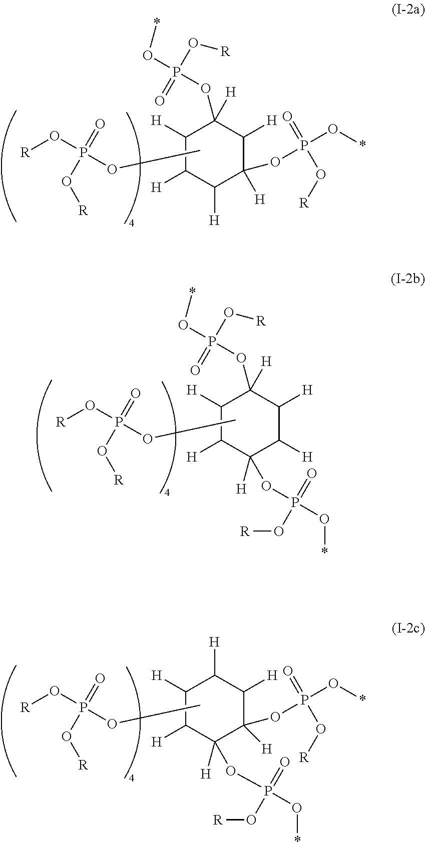

wherein R and * are as defined for formula (I).

It may preferably be provided that groups of formula (I) are independently selected from formulae (I-2a) and (I-2b) in the case where n is selected from 2.

It may preferably be provided that groups of formula (I) are independently selected from the following formulae (I-3a), (I-3b) and (I-3c) in the case where n is selected from 3:

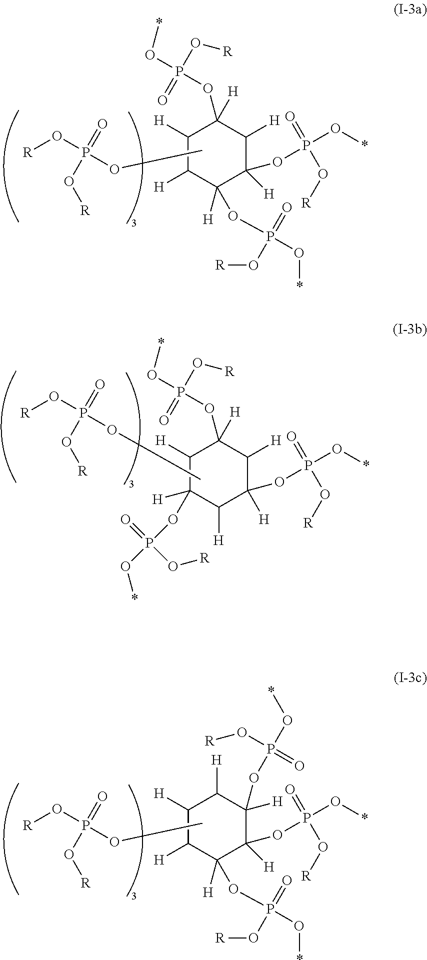

wherein R and * are as defined for formula (I).

It may preferably be provided that groups of formula (I) are independently selected from formulae (I-3a) and (I-3b), particular preferably from formula (I-3b), in the case that n is selected from 2.

It may preferably be provided that all components R are independently selected from H, substituted or unsubstituted alkyl, substituted or unsubstituted heteroalkyl, substituted or unsubstituted alkenyl, substituted or unsubstituted alkynyl, substituted or unsubstituted haloalkyl, substituted or unsubstituted haloalkenyl, substituted or unsubstituted cycloalkyl, substituted or unsubstituted cycloalkenyl, substituted or or substituted heterocycloalkyl, substituted or unsubstituted heterocycloalkenyl, substituted or unsubstituted aryl, substituted or unsubstituted heteroaryl, and substituted or unsubstituted aminocarboxylic acid.

The term “substituted”, in particular in the context of the present invention, means that the corresponding fragment has at least one residue that is not hydrogen or deuterium, wherein the residue may be selected in particular from the group consisting of halogen, —OH, C1-6 alkyl, C1-6 haloalkyl, C2-6 alkenyl, C1-6 alkoxy, and C1-6 haloalkoxy. The term “unsubstituted” in the sense of the present invention means in particular that the corresponding fragment has no residues other than hydrogen or deuterium, apart from substituents that are explicitly already described for this fragment.

It may preferably be provided that all components R are independently selected from H, substituted or unsubstituted C1-30 alkyl, substituted or unsubstituted C1-30 heteroalkyl, substituted or unsubstituted C2-30 alkenyl, substituted or unsubstituted C2-30 alkynyl, substituted or unsubstituted C1-30 haloalkyl, substituted or unsubstituted C2-30 haloalkenyl, substituted or unsubstituted C3-30 cycloalkyl, substituted or unsubstituted C3-30 cycloalkenyl, substituted or unsubstituted C2-30 heterocycloalkyl, substituted or unsubstituted C2-30 heterocycloalkenyl, substituted or unsubstituted C6-30 aryl, substituted or unsubstituted C3-30 heteroaryl, and substituted or unsubstituted C2-30 aminocarboxylic acid.

It may preferably be provided that all components R are independently selected from H, C1-30 alkyl, C1-30 heteroalkyl, C2-30 alkenyl, C2-30 alkynyl, C1-30 haloalkyl, C2-30 haloalkenyl, C3-30 cycloalkyl, C3-30 cycloalkenyl, C2-30 heterocycloalkyl, C230 heterocycloalkenyl, C6-30 aryl, C3-30 heteroaryl, and C2-30 aminocarboxylic acid.

It may preferably be provided that all components R are independently selected from H, C1-30 alkyl, C2-30 alkenyl, C2-30 alkynyl, C3-30 cycloalkyl, C3-30 cycloalkenyl, and C6-30 aryl.

It may preferably be provided that all components R are independently selected from H, C1-30 alkyl, C2-30 alkenyl, and C6-30 aryl.

It may preferably be provided that all components R are independently selected from H, C1-30 alkyl, and C6-30 aryl.

It may preferably be provided that all components R are independently selected from H, C4-20 alkyl, and C6-24 aryl.

It may preferably be provided that all components R are independently selected from H, C6-16 alkyl and C6-12 aryl.

It may preferably be provided that all components R are independently selected from H and C8-12 alkyl.

It may preferably be provided that all components R are independently selected from H and a linear C8-12 alkyl.

It may preferably be provided that all components R are independently selected from H and a linear C10 alkyl.

It may preferably be provided that m is independently selected from an integer in a range of greater than or equal to 2 to less than or equal to 5, more preferably of greater than or equal to 2 to less than or equal to 4, particularly preferably less than or equal to 3, particular preferably 2.

Preferably it may be provided that groups of formula (II) are independently selected from groups of the following formula (IIa):

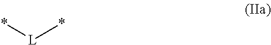

wherein L and * are as defined for formula (II).

It may preferably be provided that in the phytic acid oligomer all groups of formula (II) are selected equally, particularly preferably all groups of the formula (IIa).

L is selected from an organic linker and a siloxane linker.

### Organic Linkers:

It may preferably be provided that L is selected from substituted or unsubstituted alkyl, substituted or unsubstituted heteroalkyl, substituted or unsubstituted alkenyl, substituted or unsubstituted alkynyl, substituted or unsubstituted haloalkyl, substituted or unsubstituted haloalkenyl, substituted or unsubstituted cycloalkyl, substituted or unsubstituted cycloalkenyl, substituted or unsubstituted heterocycloalkyl, substituted or unsubstituted heterocycloalkenyl, substituted or unsubstituted aryl, substituted or unsubstituted heteroaryl, and substituted or unsubstituted aminocarboxylic acid.

It may preferably be provided that L is selected from substituted or unsubstituted C2-30 alkyl, substituted or unsubstituted C2-30 heteroalkyl, substituted or unsubstituted C2-30 alkenyl, substituted or unsubstituted C2-30 alkynyl, substituted or unsubstituted C2-30 haloalkyl, substituted or unsubstituted C2-30 haloalkenyl, substituted or unsubstituted C3-30 cycloalkyl, substituted or unsubstituted C3-30 cycloalkenyl, substituted or unsubstituted C2-30 heterocycloalkyl, substituted or unsubstituted C2-30 heterocycloalkenyl, substituted or unsubstituted C6-30 aryl, substituted or unsubstituted C3-30 heteroaryl, substituted or unsubstituted C1-30 aminoalkyl, and substituted or unsubstituted C2-30 aminocarboxylic acid.

It may preferably be provided that L is selected from C2-30 alkyl, C2-30 heteroalkyl, C2-30 alkenyl, C2-30 alkynyl, C2-30 haloalkyl, C2-30 haloalkenyl, C3-30 cycloalkenyl, C2-30 heterocycloalkyl, C2-30 heterocycloalkenyl, C6-30 aryl, C3-30 heteroaryl and C2-30 aminocarboxylic acid.

It may preferably be provided that L is selected from C2-30 alkyl, C2-30 alkenyl, C2-30 alkynyl, C3-30 cycloalkyl, C3-30 cycloalkenyl, and C6-30 aryl.

It may preferably be provided that L is selected from C1-30 alkyl, C1-30 alkenyl, and C6-30 aryl.

It may preferably be provided that L is selected from C1-30 alkyl and C6-30 aryl.

It may preferably be provided that L is selected from C2-20 alkyl and C6-24 aryl.

It may preferably be provided that L is selected from C3-12 alkyl and C6-18 aryl.

It may preferably be provided that L is selected from C4-6 alkyl and C6-12 aryl.

It may preferably be provided that L is selected from C2-12 alkyl.

It may preferably be provided that L is selected from linear C4-6 alkyl.

It may preferably be provided that L is selected from ethyl, propyl, iso-butyl, n-butyl, iso-pentyl, n-pentyl, n-hexyl, 2-methylpentyl, 3-methylpentyl, 2,2-dimethylbutyl, 2,3-dimethylbutyl, and cyclohexyl.

It may preferably be provided that L is selected from propyl, iso-butyl, n-butyl, iso-pentyl, and n-pentyl.

It may preferably be provided that L is selected from propyl, n-butyl, and n-pentyl, particularly preferably from n-butyl.

It may preferably be provided that n is independently selected from an integer in a range from greater than or equal to 1 to less than or equal to 3, and m is selected from 2, and wherein the phytic acid oligomer comprises at least two groups of formula (I) in which n is selected from 1.

It may preferably be provided that all components R are be independently selected from H and a linear C8-12 alkyl, and L is selected from propyl, iso-butyl, n-butyl, iso-pentyl, and n-pentyl.

It may preferably be provided that all components R are independently selected from H and a linear C10 alkyl, and L is selected from propyl, n-butyl, and n-pentyl, particularly preferably n-butyl.

It may preferably be provided that all components R of the phytic acid oligomer are H or the same organic residue.

It may preferably be provided that all components L of the phytic acid oligomer are the same organic linker.

It may preferably be provided that all components R of the phytic acid oligomer are H or the same organic residue, and all components L of the phytic acid oligomer are the same organic linker.

### Siloxane Linkers

It may preferably be provided that L is selected from the group

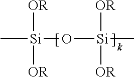

wherein k is selected from an integer from 0 to 20, preferably 0, 1 or 2, and each component R is independently from the others C1 to C4 alkyl and aryl, preferably methyl or ethyl.

Particularly preferred are compounds of the following structure:

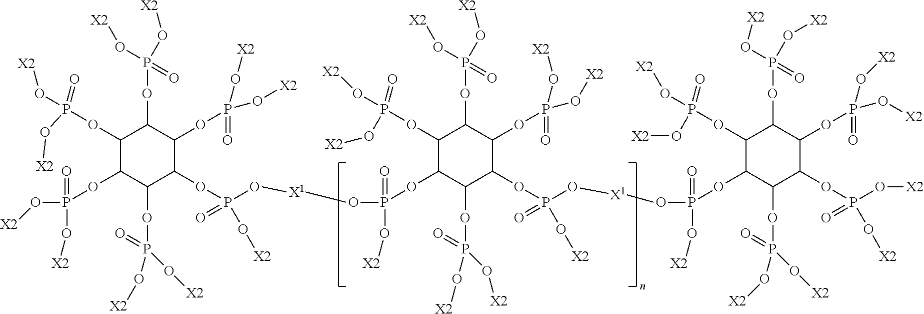

wherein X1=dimethylsiloxane, X2=aryl, alkyl, H and n=1-3

It may preferably be provided that the phytic acid oligomer has a molecular weight in a range from greater than or equal to 1,344 g/mol to less than or equal to 17,000 g/mol.

It may preferably be provided that the phytic acid oligomer has a molecular weight in a range from greater than or equal to 2,000 g/mol to less than or equal to 10,000 g/mol, more preferably 2,000 g/mol to less than or equal to 9000 g/mol, more preferably 4,000 g/mol to less than or equal to 8,000 g/mol, particularly preferably 6,000 g/mol to 7,000 g/mol.

The invention further proposes a method for producing a phytic acid oligomer according to the present invention, wherein a compound represented by the following Formula (III)

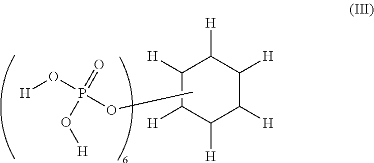

is reacted with at least one compound represented by the following formula (IV)

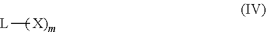

and optionally at least one compound of the following formula (V)

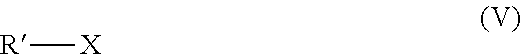

under the influence of temperature to form the phytic acid oligomer,
wherein m is independently selected from an integer in a range of greater than or equal to 2 to less than or equal to 6,
wherein R′ is selected from an organic residue,
wherein L is selected from an organic linker or a siloxane linker;
and wherein each component X is independently selected from a functional group that can be reacted with formula (III) to form a phosphoric acid ester.

The preferred values for m in formula (I) are also preferred for m in formula (IV).

The preferred implementations for L in formula (I) are also preferred for L in formula (IV).

It may preferably be provided that in formula (IV) X is selected from OH.

It may preferably be provided that formula (IV) is selected from C1-30 alkanediol, C1-30 alkenediol, and C6-30 aryldiol.

A phytic acid oligomer according to any one of claims 1 to 3, wherein L is selected from C1-30 alkanediol and C6-30 aryldiol.

It may preferably be provided that L is selected from C2-20 alkanediol and C6-24 aryldiol.

It may preferably be provided that L is selected from C3-12 alkanediol and C6-18 aryldiol.

It may preferably be provided that L is selected from C4-6 alkanediol and C6-12 aryl diol.

It may preferably be provided that L is selected from C2-12 alkanediol.

It may preferably be provided that L is selected from linear C4-6 alkanediol.

It may preferably be provided that L is selected from ethanediol, propanediol, iso-butanediol, n-butanediol, iso-pentanediol, n-pentanediol, n-hexanediol, 2-methylpentanediol, 3-methylpentanediol, 2,2-dimethylbutanediol, 2,3-dimethylbutanediol, and cyclohexanediol.

It may preferably be provided that L is selected from propanediol, iso-butanediol, n-butanediol, iso-pentanediol, and n-pentanediol.

It may preferably be provided that L is selected from propanediol, n-butanediol, and n-pentanediol, particularly preferably from n-butanediol, in particular 1,4-n-butanediol.

It may preferably be provided that L is selected from the following group:

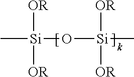

wherein k is selected from an integer from 0 to 20, preferably 0, 1 or 2 and each component R is independently from the others C1 to C4 alkyl and aryl, preferably methyl or ethyl.

It may preferably be provided that R′ is selected just like R, except H. In other words, it may preferably be provided that the organic residue R′ is selected from the same group as the organic residue R.

It may preferably be provided that in formula (V) X is selected from OH.

It may preferably be provided that the compound of formula (V) is selected from C1-30 alkyl alcohol, C2-30 alkenyl alcohol, and C6-30 aryl alcohol.

It may preferably be provided that the compound of formula (V) is selected from C1-30 alkyl alcohol and C6-30 aryl alcohol.

It may preferably be provided that the compound of formula (V) is selected from C4-20 alkyl alcohol and C6-24 aryl alcohol.

It may preferably be provided that the compound of formula (V) is selected from C4-20 alkyl alcohol and C6-24 aryl alcohol.

It may preferably be provided that the compound of formula (V) is selected from C6-16 alkyl alcohol and C6-12 aryl alcohol.

It may preferably be provided that the compound of formula (V) is selected from C8-12 alkyl alcohol.

It may preferably be provided that the compound of formula (V) is selected from a linear C8-12 alkyl alcohol.

It may preferably be provided that the compound of formula (V) is selected from a linear C10 alkyl alcohol.

It may preferably be provided that the compound of formula (V) is selected from saturated or unsaturated fatty alcohols.

It may preferably be provided that the compound of formula (V) is selected from caprylic alcohol, lauryl alcohol, margaryl alcohol, stearyl alcohol, arachidyl alcohol, behenyl alcohol, lignoceryl alcohol, ceryl alcohol, montanyl alcohol, melissyl alcohol, palmitoleyl alcohol, oleyl alcohol, elaidyl alcohol, linoleyl alcohol, and γ-linolenyl alcohol.

It may preferably be provided that the compound of formula (V) is selected from saturated fatty alcohols.

It may preferably be provided that the compound of formula (V) is selected from caprylic alcohol, lauryl alcohol, margaryl alcohol, stearyl alcohol, arachidyl alcohol, behenyl alcohol, lignoceryl alcohol, ceryl alcohol, montanyl alcohol, and melissyl alcohol.

It may preferably be provided that the compound of formula (V) is selected from capryl alcohol, lauryl alcohol, margaryl alcohol, and stearyl alcohol.

It may preferably be provided that the compound of formula (V) is selected from lauryl alcohol.

It may preferably be provided that all components R′ are independently selected from a linear C8-12 alkyl, and L is selected from propyl, iso-butyl, n-butyl, iso-pentyl, and n-pentyl.

It may preferably be provided that all components R′ are independently selected from a linear C10 alkyl, and L is selected from propyl, n-butyl, and n-pentyl, particularly preferably from n-butyl.

It may preferably be provided that all components R′ are the same organic residue.

It may preferably be provided that all components L are the same organic linker.

It may preferably be provided that all components X are the same functional group.

It may preferably be provided that all components R are the same organic residue and all components L are the same organic linker.

It may preferably be provided that all components R are the same organic residue, all components L are the same organic linker and all components X are the same functional group.

It may preferably be provided that in formula (IV) and optionally in formula (V) X is selected from OH.

It may preferably be provided that the compounds of the formulae (III), (IV) and optionally (V) are reacted with each other stoichiometrically in relation to the desired phytic acid oligomer.

It may preferably be provided that the molar ratio of the compound of formula (III) used to the compound of formula (IV) used is less than or equal to 3:2 to greater than or equal to 1, more preferably greater than or equal to 20:19, more preferably greater than or equal to 10:9, more preferably greater than or equal to 6:5, more preferably greater than or equal to 5:4, particularly preferably greater than or equal to 4:3.

It may preferably be provided that the molar ratio of the compound of formula (III) used to the compound of formula (V) used is less than or equal to 1:12 to greater than or equal to 1:1, more preferably less than or equal to 1:11 to greater than or equal to 1:4, more preferably less than or equal to 1:10 to greater than or equal to 1:6, particularly preferably less than or equal to 1:9 to greater than or equal to 1:8.

It may preferably be provided that the molar ratio of the compound of formula (III) used to the compound of formula (IV) used is less than or equal to 3:2 to greater than or equal to 4:3, and the molar ratio of the compound of formula (III) used to the compound of formula (V) used is less than or equal to 1:9 to greater than or equal to 1:8.

It may preferably be provided that the reaction takes place with the deposition of a condensation product, preferably with the deposition of water.

It may preferably be provided that the compounds of formula (IV) and optionally (V) for the reaction of the process are dissolved in an organic solvent, preferably in an aprotic organic solvent such as toluene.

It may preferably be provided that the compound of formula (III) for the reaction of the process is dissolved in a polar solvent, preferably a protic solvent such as water.

It may preferably be provided that the reaction of the process is carried out in a water separator.

It may preferably be provided that the process is carried out at a temperature in a range from greater than or equal to 100° C. to less than or equal to 200° C., more preferably from greater than or equal to 120° C. to less than or equal to 190° C., more preferably from greater than or equal to 140° C. to less than or equal to 180° C., particularly preferably from greater than or equal to 150° C. to less than or equal to 170° C.

It may preferably be provided that the reaction is carried out until the deposition of the theoretical amount of depositable condensation products or until no further condensation product is deposited.

The invention also proposes a use of the phytic acid oligomer for the production of a polymer composition.

In one preferred embodiment it may be provided that the phytic acid oligomer is used as a curing agent for crosslinking a resin, in particular an epoxy resin or an OH-functionalized acrylate.

In an alternative preferred embodiment it may be provided that the phytic acid oligomer is used with a curing agent.

The invention also proposes a method for producing a polymer composition comprising the phytic acid oligomer according to the present invention, wherein the phytic acid oligomer according to the present invention is blended with reactants under the influence of temperature.

It may preferably be provided that the phytic acid oligomer is blended with an epoxy resin or an OH-functionalized acrylate under the influence of temperature.

The invention also proposes a polymer composition produced by the method according to the invention, wherein the polymer composition comprises the phytic acid oligomer according to the invention.

The invention is explained in more detail with reference to the figures and examples.

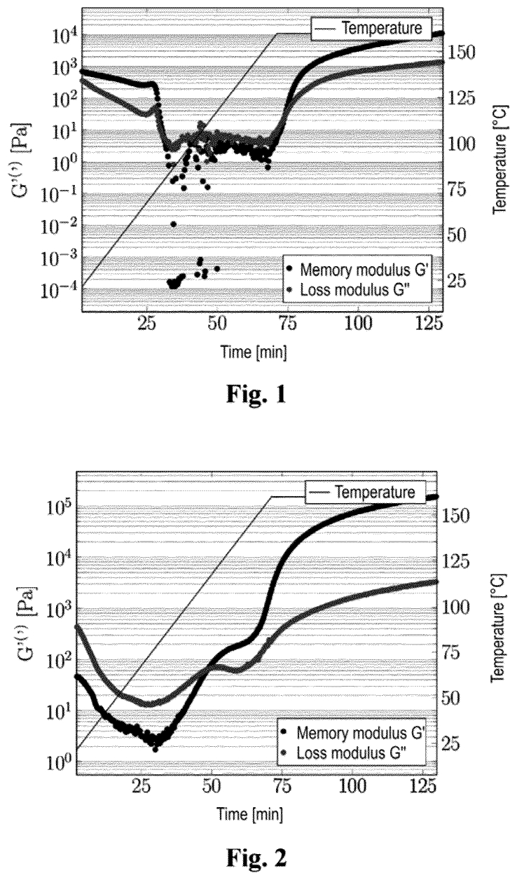

FIG. 1 schematically shows the course of temperature, memory modulus G′ and loss modulus G″ for a crosslinking reaction of a phytic acid oligomer according to the invention with a water-based epoxy;

FIG. 2 schematically shows the course of temperature, memory modulus G′ and loss modulus G″ for a crosslinking reaction of a phytic acid oligomer according to the invention with a solvent-based epoxy;

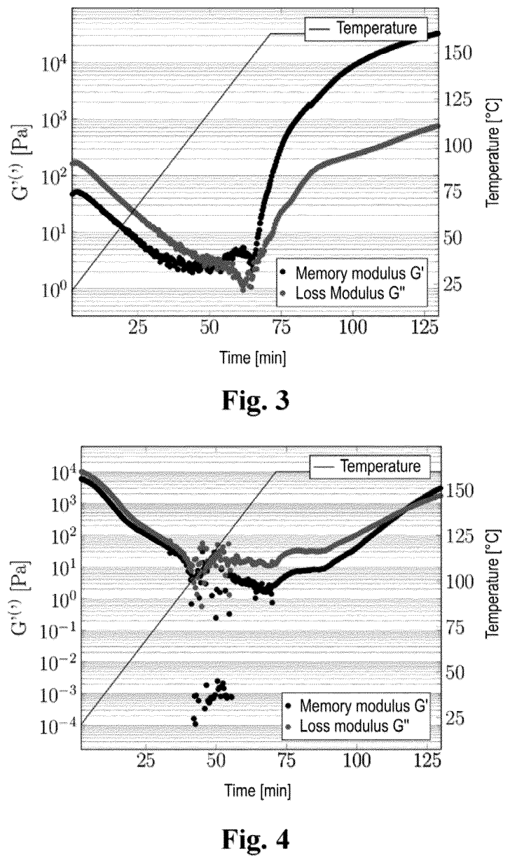

FIG. 3 schematically shows the course of temperature, memory modulus G′ and loss modulus G″ for a crosslinking reaction of a phytic acid oligomer according to the invention with a solvent-based OH acrylate;

FIG. 4 schematically shows the course of temperature, memory modulus G′ and loss modulus G″ for a crosslinking reaction of a phytic acid oligomer according to the invention with a water-based OH acrylate;

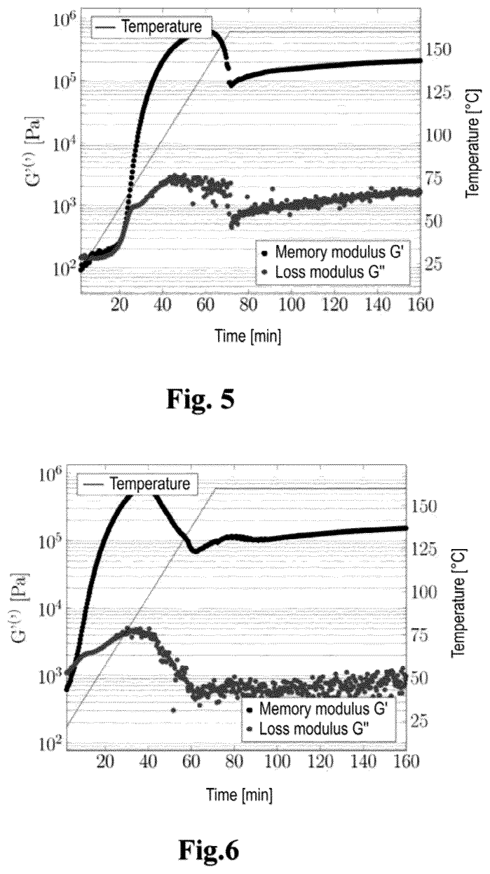

FIG. 5 schematically shows the course of temperature, memory modulus G′ and loss modulus G″ for a crosslinking reaction of a phytic acid oligomer according to the invention with a water-based epoxy;

FIG. 6 schematically shows the course of temperature, memory modulus G′ and loss modulus G″ for a crosslinking reaction of a phytic acid oligomer according to the invention with a solvent-based epoxy;

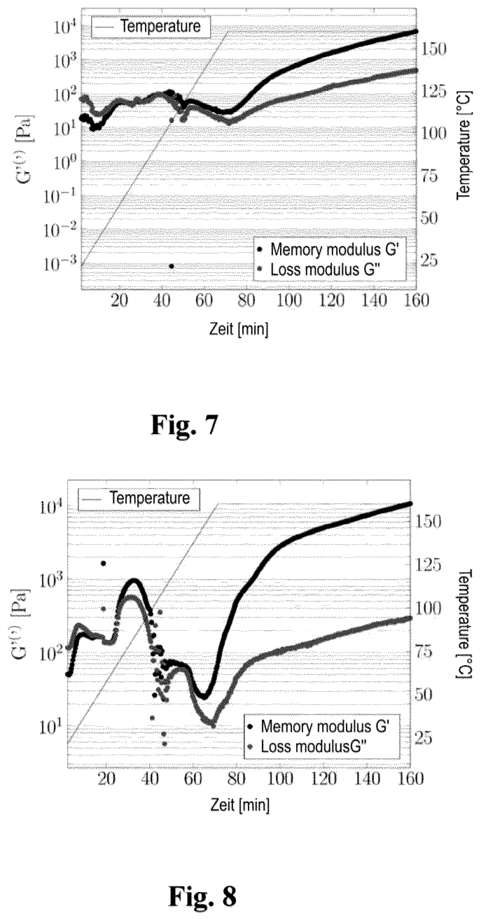

FIG. 7 schematically shows the course of temperature, memory modulus G′ and loss modulus G″ for a crosslinking reaction of a phytic acid oligomer according to the invention with a solvent-based OH acrylate;

FIG. 8 schematically shows the course of temperature, memory modulus G′ and loss modulus G″ for a crosslinking reaction of a phytic acid oligomer according to the invention with a water-based OH acrylate;

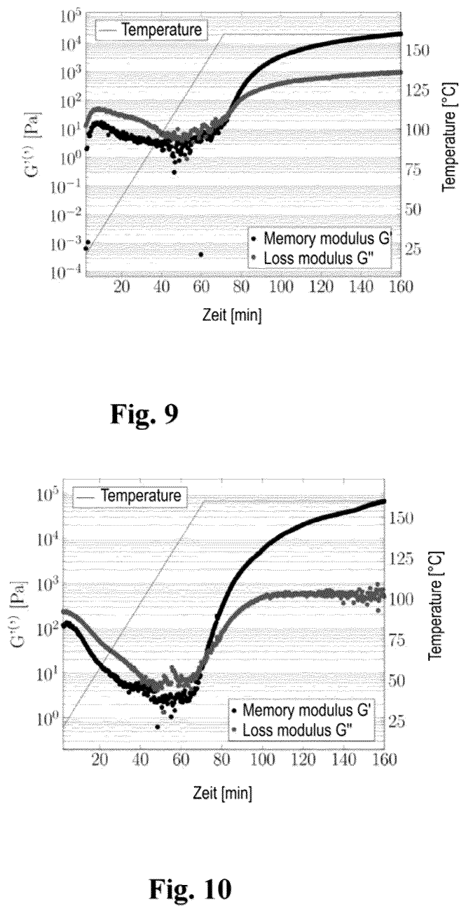

FIG. 9 schematically shows the course of temperature, memory modulus G′ and loss modulus G″ for a crosslinking reaction of a phytic acid oligomer according to the invention with a water-based epoxy;

FIG. 10 schematically shows the course of temperature, memory modulus G′ and loss modulus G″ for a crosslinking reaction of a phytic acid oligomer according to the invention with a solvent-based epoxy; and

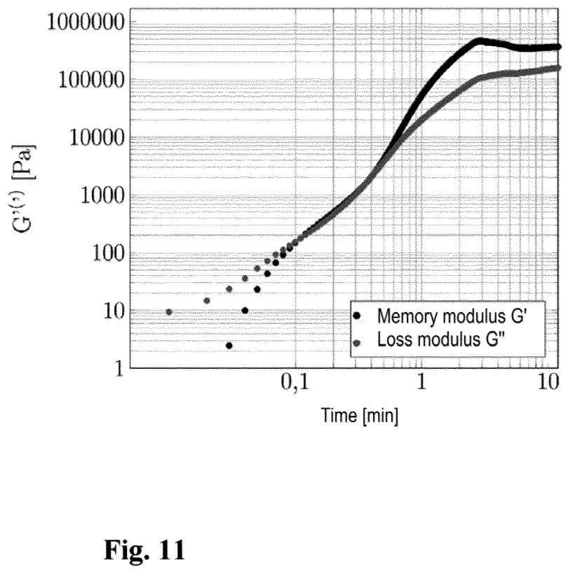

FIG. 11 schematically shows the course of temperature, memory modulus G′ and loss modulus G″ for a crosslinking reaction of a phytic acid oligomer according to the invention with bisphenol-A-diglycidether.

### PRODUCTION OF A PHYTIC ACID OLIGOMER ACCORDING TO THE INVENTION

In a four-neck flask with a water trap, dropping funnel, condenser and stirrer motor, 2 mol of butanediol were weighed in with 26 mol of lauryl alcohol and a quantity of toluene adapted to the flask. The mixture was heated in a preheated oil bath to 160° C. and stirred until all components were dissolved. Subsequently, 3 mol of phytic acid were added quickly as an aqueous solution (>75 wt.-% phytic acid). After the foam formation had decreased somewhat, the reaction water was started to be drawn off. After reaching the theoretical amount of water separated off, the reaction mixture was cooled with stirring and the phytic acid oligomer was isolated from the toluene phase. Non-reacted phytic acid could be washed out with water.

### Production of Polymer Compositions According to the Invention

The phytic acid oligomer according to the invention was blended with a reactant selected from a water-based epoxy (Beckopox 387w/52wa), a solvent-based epoxy (Beckopox EP 301/75x), a solvent-based OH acrylate (Macrynal sm 500/60x) and a water-based OH acrylate (Bayhydrol A 2470) in a DAC 150.1 FV Speedmixer and respectively applied with a rubber spatula to glass or steel plates to a thickness of 120 μm. The films obtained were dried at 80° C. for 15 minutes and then at 160° C. for 30 minutes.

Well-adhering polymer coatings were obtained.

### Technical Effect

Furthermore, corresponding polymer compositions were prepared directly in a rotational rheometer (Anton Paar MCR 102). To this end, the starting materials described above were used. A plate geometry of 25 mm was used and the measurements were carried out in the linear viscoelastic range with a deformation of γ=0.1%, a frequency f=10 rad/s and a measuring gap of 1 mm. The temperature was increased by 2° C./min, up to a maximum of 160° C. and held there for up to one hour. The glass transition temperature of the polymer composition obtained was then measured with the same rotational rheometer, wherein the samples were measured at 0.5° C./min from 20° C. to 160° C. with a deformation of γ=0.1% and a frequency of f=10 rad/s.

Further measurements were carried out as follows:
impact test according to EN ISO 6272-1,
cross cutting test according to DIN EN ISO 2409,
pendulum damping test according to EN ISO 1522,
chemical resistance according to DIN EN ISO 2812-4,
contact angle measurement according to DIN EN ISO 19403-2020.

A successful crosslinking of the phytic acid oligomer could be shown with the rotational rheometer. The results of the measurements during the production of the polymer composition are shown in FIGS. 1 to 4. These show respectively that the compositions crosslink from a liquid to a gel at a gel point. The gel point is defined as the point at which the liquid or dissolved reaction mixture forms larger networks and becomes a gel. The various graphs in FIGS. 1 through 4 show that the gel point was reached shortly after the reaction temperature reached 160° C. Only the reaction with Bayhydrol® A 2470 required a longer reaction time.

The resulting polymer compositions had glass transition temperatures T_{g} as listed in Table 1:

TABLE 1
Glass transition temperatures

| Phytic acid oligomer with | Tg [° C.] |
|---|---|
| Beckopox ™ EP 387w/52wa | 73.4 |
| Beckopox ™ EP301/75x | 67.0 |
| Macrynal ™ SM 500/60x | 53.3 |
| Bayhydrol ® A 2470 | 75.1 |

The polymer compositions obtained had properties as coatings comparable to those of conventional coatings. The results of the measurements are shown in Table 2.

In particular, the pendulum hardness is comparable to the pendulum hardness of known systems. The contact angle with water shows that the phytic acid oligomer used is sufficiently hydrophobic.

The more elastic epoxides also showed good properties in the impact test.

All systems showed good resistance to water. Only the water-based systems showed turbidity or softening with acetone. All systems showed no good resistance to methyl ethyl ketone, similar to known systems.

Overall, all measured properties of the obtained polymer compositions were comparable to those of systems prepared with known crosslinkers instead of the phytic acid oligomer according to the invention. Advantages arise in particular from the aspect of renewable raw materials and the phosphate content of the polymer compositions, which can be advantageous for corrosion protection properties.

TABLE 2
Results of measurements.

| | | Contact | | | Chemical resistance (24 h) | | |
|---|---|---|---|---|---|---|---|
| | Pendulum | angle | Cutting | Impact | | | Methyl |
| Phytic acid | hardness | (water) | test | test | | | ethyl |
| oligomer with | (König) | in ° | (1 mm) | (1 m) | Water | Acetone | ketone |
| Beckopox | 77 | 82.73 | 0 | ok | No | Light | Light |
| 387w/52wa | | | | | change | turbidity | softening |
| Beckopox EP | — | — | — | ok | No | No | Light |
| 301/75x | | | | | change | change | softening |
| Macrynal sm | 100 | 93.85 | 1 | broken | No | No | Partly |
| 500/60x | | | | | change | change | removed |
| Bayhydrol A | 71 | 85.87 | 3 | broken | No | Light | Softening |
| 2470 | | | | | change | softening | and |
| | | | | | | | turbidity |

### Preparation of Further Polymer Compositions According to the Invention

In a manner analogous to that described above, the following two oligomers PH-A and PH-B were prepared:

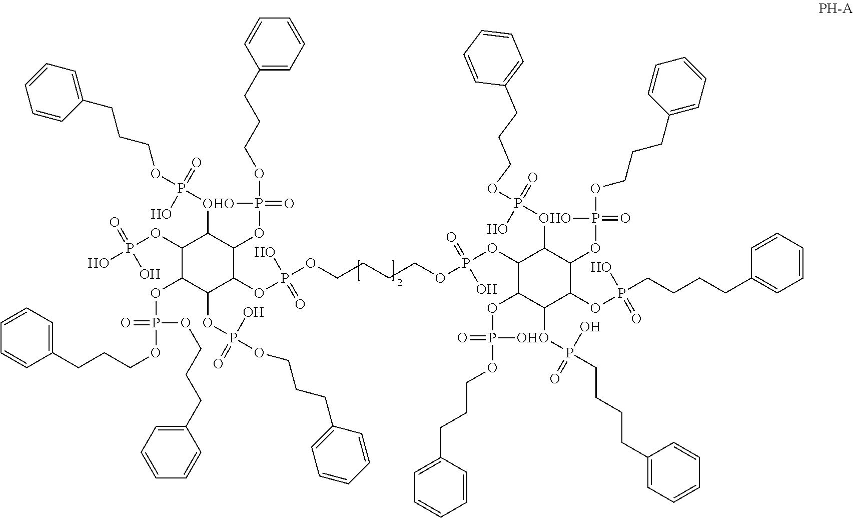

Yield: 95.6%

Meq: 245.7 g/eq.

¹H-NMR (400 D₆-DMSO, d, ppm): 1.28 (m, j=6, —(CH₂)₄—CH₂—CH₂—O); 1.54 (m; —CH₂—CH₂—O); 1.86 (qint, J=6.5 (O—CH₂—CH₂—CH₂-aromat); 2.62 (m, CH₂-aromat); 3.86 (multi, P—O—CH₂—CH₂—); 7.23 (multi, (aromat-H)

¹³C-NMR (300 D₆-DMSO, ppm): 30.98-31.76 (various CH₂); 64.57 & 64.63 (various CH₂—O—P); 125.33 & 125.83 & 125.87 & 128.92 & 141.19 & 141.39 (various aromatic CH)

³¹P-NMR (300 MHZ, D₆-DMSO, ppm): −1.04, −1.34 [phosphate ester] [12, 13]

IR (resonance in [cm⁻¹]: 3085, 3064, 3032 (stretch, C—H); 2937 (asym. stretch CH₂), 2861 (sym. stretch CH₂); 2669 & 2325 (board, stretch P—OH vibration); 1658 (board, stretch [P═O]—OH); 1600, 1581 (stretch C═C); 1498 (def. CH₂); 1469 (mono substituted aromatic C═C); 1454 (def. CH₂); 1390 (wagging CH₂); 1209-1111 (various stretch P═O); 995 (asym. stretch P—O—C); 478 ((RO)₂(HO)P═O [6.8]

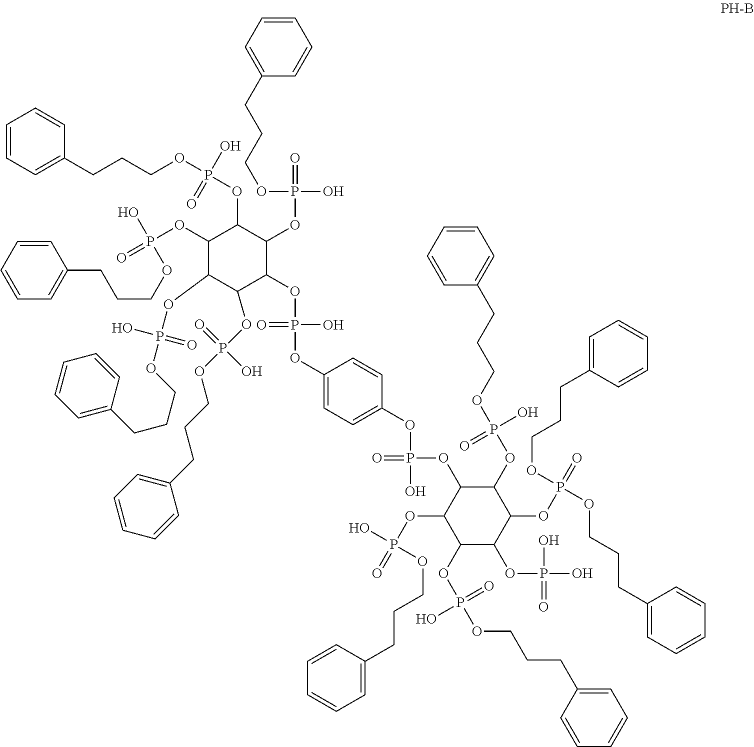 [SMILES: O=P(O)(O)OC1C(OP(=O)(O)OCCCc2ccccc2)C(OP(=O)(O)OCCCc2ccccc2)C(OP(=O)(O)Oc2ccc(OP(=O)(O)OC3C(OP(=O)(O)OCCCc4ccccc4)C(OP(=O)(O)OCCCc4ccccc4)C(OP(=O)(O)OCCCc4ccccc4)C(OP(=O)(O)OCCCc4ccccc4)C3OP(=O)(O)OCCCc3ccccc3)cc2)C(OP(=O)(O)OCCCc2ccccc2)C1OP(=O)(OCCCc1ccccc1)OCCCc1ccccc1]

Yield: >99%

Meq: 140.1 g/eq

¹H-NMR (300 MHZ, D₆-DMSO, d, ppm): 1.86 (qint, J=6.5 (O—CH₂—CH₂—CH₂ aromat); 2.62 (m, CH₂-aromat) 3.86 (multi, P—O—CH₂—CH₂—); 7.23 (multi, (aromatic-H)

¹³C-NMR (300 MHz, D₆-DMSO, ppm): 30.97-31.71 (various CH₂); 64.56 & 64.62 (CH₂—O); 69.76 (aromat-CH₂—O); 125.32 & 125.83 & 125.88 & 128.32 & 128.91 & 141.19 & 141.39 (various aromatic C—H);

³¹P-NMR (300 MHZ, D₆-DMSO, ppm): −1.04 & −1.12 [phosphate ester]; −13 26 [polyphosphate] [12, 13]

IR (resonance in [cm⁻¹]: 3081, 3060, 3023 (stretch, C—H); 2919 (asym. stretch CH₂), 2863 (sym. stretch CH₂); 2663, 2318 (board, stretch P—OH vibration); 1660 (board, stretch [P═O]—OH); 1604, 1581 (stretch C═C); 1488 (def. CH₂); 1473 (mono substituted aromatic C═C); 1457 (def. CH₂); 1388 (wagging CH₂); 1209-1114 (various stretch P═O); 997 (asym. stretch P—O—C); 472 ((RO)₂(HO)P═O) [6.8]

The two oligomers were subsequently crosslinked. The results can be seen in the following table:

| | PH-A | | PH-B | |
|---|---|---|---|---|
| | Water- | Solvent- | Water- | Solvent- |
| | based | based | based | based |
| | Becko- | (BuAc) | Becko- | (BuAc) |
| | pox ™ | Beckopox ™ | pox ™ | Beckopox ™ |
| Binder | 301/75X | 387W/52WA | 301/75X | 387W/52WA |

Curing at 160° C.

| | | | | |
|---|---|---|---|---|
| Pendulum | 53 | 117 | 21 | 107 |
| hardness | | | | |
| Gloss | 0.5; 6; 59 | 24; 71; 82 | 5; 39; 71 | 52; 78; 86 |
| [20°; 60°; 85°] | | | | |
| L* [65K; 10°] | 36.8 | 36.9 | 35.5 | 37.3 |
| a* [65K; 10°] | 20.3 | 22.6 | 23.3 | 22.9 |
| b* [65K; 10°] | c | 13.1 | 13.5 | 14.3 |

Curing at room temperature

| | | | | |
|---|---|---|---|---|
| Pendulum | 33 | 60 | 39 | 46 |
| hardness | | | | |
| Gloss | 49; 82; 91 | 63; 91; 94 | 31; 71; 81 | 52; 78; 86 |
| [20°; 60°; 85°] | | | | |
| L* [65K; 10°] | 36.1 | 37.0 | 36,9 | 37.5 |
| a* [65K; 10°] | 22.8 | 22.3 | 23.0 | 23.1 |
| b* [65K; 10°] | 13.3 | 12.7 | 14.3 | 14.3 |

FIG. 5 schematically shows the course of temperature, memory modulus G′ and loss modulus G″ for a crosslinking reaction of PH-A with Beckopox™ 301/75X in butyl acetate, FIG. 6 shows the analogous graph for PH-B.

FIG. 7 schematically shows the course of temperature, memory modulus G′ and loss modulus G″ for a crosslinking reaction of PH-A with Beckopox™ 301/75X in water, FIG. 8 shows the analogous graph for PH-B.

FIG. 9 schematically shows the course of temperature, memory modulus G′ and loss modulus G″ for a crosslinking reaction of PH-A with Macyrnal® SM 500/60X in butyl acetate, FIG. 10 shows the analogous graph for PH-B.

FIG. 11 schematically shows the course of temperature, memory modulus G′ and loss modulus G″ for a crosslinking reaction of PH-A with bisphenol-A-diglycidether.

Subsequently, several pigment pastes were prepared in an analogous manner as above, consisting of:
69% Bayferrox® 130M
17% PA oligomer (PH-A or PH-B)
16% water or butyl acetate

In each case, the PA oligomer (PH-A or PH-B) was dissolved in the solvent or dispersed in water. Subsequently, Bayferrox 130M was added with stirring and homogenized in the speed mixer. The resulting pigment paste is stable for at least 3 weeks.

Preparation of an Oligomer According to the Invention with a Siloxane Linker:

In a four-neck flask with a water trap, two dropping funnels, a cooler, foam breaker and stirrer motor, 26 moles of 3-phenylpropanol and a quantity of toluene adapted to the flask where weighted in. This mixture is heated in a preheated oil bath to boiling conditions. subsequently, 3 moles of phytic acid and 2 moles of polydimethylsiloxane are added slowly simultaneously through a dropping funnel. After reaching the theoretical amount of deposited water, the reaction mixture is cooled while stirring. Phytic acid that has not reacted can be washed out with water.

The individual combinations of the ingredients and the features of the embodiments already mentioned are exemplary; the interchange and substitution of these teachings with other teachings included in the present document and in the cited documents are also expressly contemplated. Those skilled in the art recognize that variations, modifications, and other embodiments described herein can also be made without departing from the spirit and scope of the invention.

Accordingly, the above description is exemplary and not to be regarded as limiting. The word “comprise” as used in the claims does not exclude other components or steps. The indefinite article “a” does not exclude the meaning of plural. The mere fact that certain measures are recited in mutually different claims does not indicate that a combination of these measures cannot be used to advantage. The scope of the invention is defined in the following claims and their equivalents.

1. A phytic acid oligomer consisting of at least two independently selected groups of the following formula (I) 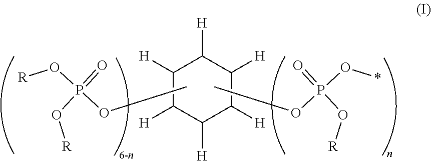
and at least one independently selected group of the following formula (II) 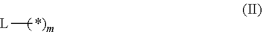
wherein n is independently selected from an integer in a range from greater than or equal to 1 to less than or equal to 6,
m is independently selected from an integer in a range from greater than or equal to 2 to less than or equal to 6,
each R is independently selected from H or an organic residue,
wherein L is selected from an organic linker or a siloxane linker, and
wherein each group of formula (II) connects at least two independent groups of formula (I) via covalent bonds to each other, wherein the asterisks “*” represent bonding positions.

2. The phytic acid oligomer according to claim 1, wherein in said phytic acid oligomer at least two of all components R are together selected from H, and the remaining components R are not H.

3. The phytic acid oligomer according to claim 1, wherein all components R are independently selected from H, C1-30 alkyl, and C6-30 aryl.

4. The phytic acid oligomer according to claim 1, wherein L is selected from C1-30 alkyl and C6-30 aryl.

5. The phytic acid oligomer according to claim 1, wherein said phytic acid oligomer has a molecular weight in a range from greater than or equal to 1,344 g/mol to less than or equal to 17,000 g/mol.

6. A method for producing the phytic acid oligomer according to claim 1, wherein a compound of the following formula (III) 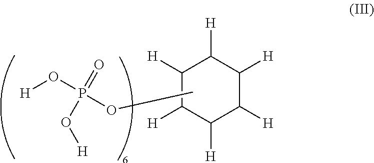
comprising at least one compound of the following formula (IV) 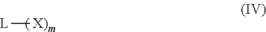
and optionally at least one compound of the following formula (V) 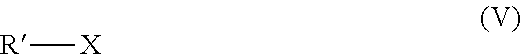
are reacted with each other under the influence of temperature to form the phytic acid oligomer,
wherein m is independently selected from an integer in a range from greater than or equal to 2 to less than or equal to 6,
wherein R′ is selected from an organic residue,
wherein L is selected from an organic linker or a siloxane linker,
and wherein all components X are independently selected from a functional group that can be reacted with formula (III) to form a phosphoric ester.

7. The method according to claim 6, wherein the reaction is carried out with the deposition of a condensation product, preferably with the deposition of water.

8. Use of the phytic acid oligomer according to claim 1 for the production of a polymer composition.

9. A method for producing a polymer composition comprising the phytic acid oligomer according to claim 1, wherein the phytic acid oligomer according to claim 1 is blended with a reactant under the influence of temperature.

10. A polymer composition produced by the method according to claim 9, wherein the polymer composition comprises the phytic acid oligomer according to claim 1.
